(19) United States
(12) Patent Application Publication
(10) Pub. No.: US 2024/0189994 A1
(43) Pub. Date: Jun. 13, 2024

(54) REAL-WORLD ROBOT CONTROL USING TRANSFORMER NEURAL NETWORKS

(71) Applicant: Google LLC, Mountain View, CA (US)

(72) Inventors: Keerthana P G, San Francisco, CA (US); Karol Hausman, San Francisco, CA (US); Julian Ibarz, Sunnyvale, CA (US); Brian Ichter, Brooklyn, NY (US); Alexander Irpan, Palo Alto, CA (US); Dmitry Kalashnikov, Fair Lawn, NJ (US); Yao Lu, Palo Alto, CA (US); Kanury Kanishka Rao, Santa Clara, CA (US); Michael Sahngwon Ryoo, Mountain View, CA (US); Austin Charles Stone, San Francisco, CA (US); Teddey Ming Xiao, Mountain View, CA (US); Quan Ho Vuong, Palo Alto, CA (US); Sumedh Anand Sontakke, Los Angeles, CA (US)

(21) Appl. No.: 18/539,171

(22) Filed: Dec. 13, 2023

Related U.S. Application Data
(60) Provisional application No. 63/432,373, filed on Dec. 13, 2022.

(51) Int. Cl. B25J 9/16

(52) U.S. Cl. CPC B25J 9/163; B25J 9/161

(57) ABSTRACT

Methods, systems, and apparatus, including computer programs encoded on a computer storage medium, for controlling an agent interacting with an environment. In one aspect, a method comprises: receiving a natural language text sequence that characterizes a task to be performed by the agent in the environment; generating an encoded representation of the natural language text sequence; and at each of a plurality of time steps: obtaining an observation image characterizing a state of the environment at the time step; processing the observation image to generate an encoded representation of the observation image; generating a sequence of input tokens; processing the sequence of input tokens to generate a policy output that defines an action to be performed by the agent in response to the observation image; selecting an action to be performed by the agent using the policy output; and causing the agent to perform the selected action.

### CROSS-REFERENCE TO RELATED APPLICATION

This application claims priority to U.S. Provisional Application No. 63/432,373, filed on Dec. 13, 2022. The disclosure of the prior application is considered part of and is incorporated by reference in the disclosure of this application.

### BACKGROUND

This specification relates to controlling agents using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that controls an agent, e.g., a robot, that is interacting in an environment by selecting actions to be performed by the agent and then causing the agent to perform the actions.

The subject matter described in this specification can be implemented in particular embodiments so as to realize one or more of the following advantages. A policy system, as described in this specification, is a neural network system that implements a multi-task neural network backbone that can control an agent, e.g., a robot, to perform any of a wide variety of real-world robotic control tasks. By leveraging open-ended task-agnostic training that extends beyond robotic control, a high-capacity and data-efficient architecture that can learn knowledge present in large-scale datasets, or both, the policy system is able to solve specific downstream robotic control tasks either zero-shot, or with a relatively small task-specific datasets, to a high level of performance.

In addition, the policy system can control an agent with reduced latency, e.g., can generate policy output specifying an action to be performed by the agent in response to observation images at a frequency of 3 Hz, or higher. This reduced latency ensures that the policy system can control the agent to move in a more natural and fluid way, which in turn, results in higher precision agent movements that may be key to successful task accomplishments.

Furthermore, once trained, the policy system can control a robot on new tasks (involving new environments, new objects, or both) that were previously unseen during the training of the policy system. This generalization capability of the policy system is advantageous because it extends the applicability of the described policy system to complex robotic control tasks, e.g., dexterous tasks, long-horizon tasks, and so forth, the demonstration data for which is difficult or computationally expensive to obtain.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example policy system and an example control system.

FIG. 2 is an illustration of an architecture of an example policy system.

FIG. 3 is an illustration of operations performed by an example policy system.

FIG. 4 is a flow diagram of an example process for controlling an agent interacting with an environment.

FIG. 5 is a flow diagram of an example process for training a set of neural networks included in a policy system.

FIG. 6 is an illustration of training a set of neural networks on a mixed training dataset.

FIG. 7 shows a quantitative example of the performance gains that can be achieved by using a policy system described in this specification.

Like reference numbers and designations in the various drawings indicate like elements.

### DETAILED DESCRIPTION

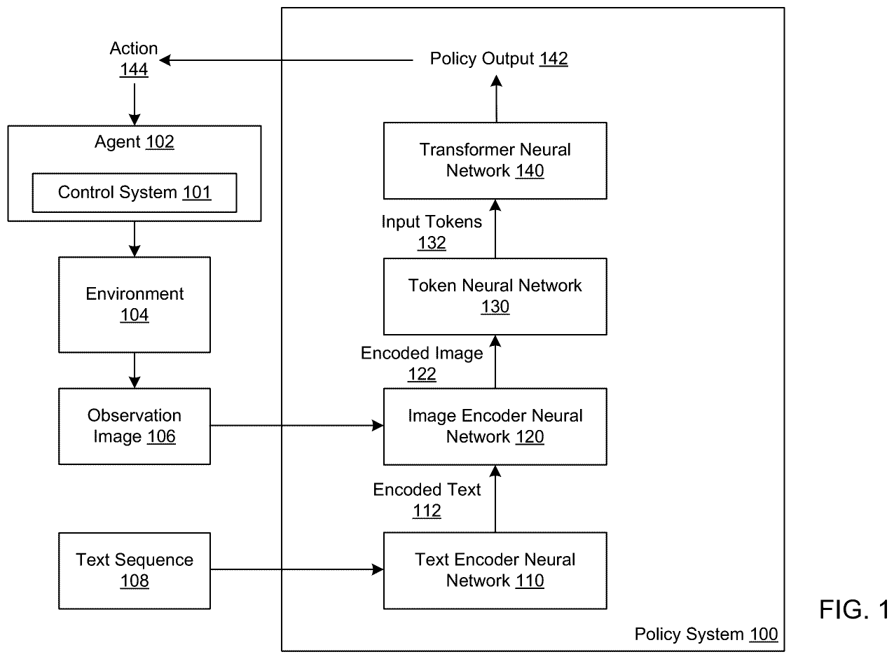

FIG. 1 shows an example policy system 100 and an example control system 101. The policy system 100 and the control system 101 are examples of a system implemented as computer programs on one or more computers in one or more locations in which the systems, components, and techniques described below are implemented.

The policy system 100 and the control system 101 can control an agent 102, e.g., a robot, to accomplish any of a wide variety of tasks in the environment 104. To control the agent 102 that is interacting in the environment 104 to accomplish a task, the policy system 100 selects actions 144 to be performed by the agent 102, and the control system 101 then causes the agent 102 to perform the selected actions 144.

As a general example, the task can include one or more of, e.g., navigating to a specified location in the environment 104, identifying a specific object in the environment 104, manipulating the specific object in a specified way, controlling items of equipment to satisfy criteria, and so on. To accomplish such a task, the agent 102 moves, e.g., navigates and/or changes its configuration, within the environment 104.

Typically, the control system 101 is local to the agent 102. For example, the control system 101 can be on-board the agent 102, e.g., can be implemented on one or more computers, a local workstation, or a local server having relatively small processing and memory resources that is on-board the agent 102.

In some implementations, the policy system 100 is local to the agent 102. For example, like the control system 101, the policy system 100 can also be on-board the agent 102. Moreover, in some of these implementations, the policy system 100 can be a part of the control system 101 which causes the agent 102 to perform actions 144.

In other implementations, the policy system 100 is remote from the agent 102. For example, unlike the control system 101, the policy system 100 can be hosted within a data center, which can be a distributed computing system having hundreds or thousands of computers in one or more locations. That is, the control system 101 can receive data identifying the actions 144 from an external source, e.g., rather than generating such data on-board the agent 102.

In these implementations, the policy system 100 and the control system 101 can be connected by a data communication network, such as a local area network (LAN), a wide area network (WAN), the Internet, or a combination thereof.

In these implementations, the control system 101 of the agent 102 interacts with a remote policy system 100 that is hosted within a data center with much more computing and other resources than those available on-board the agent 102 to reduce the latency in selecting actions 144, reduce the consumption of the limited power supply of the agent 102 when selecting actions 144, or both.

In some implementations, the policy system 100, the control system 101, or both can expose one or more application programming interfaces (APIs) or other data interfaces that facilitate the control of the agent 102. For example, a user of the agent 102 may use an API made available by the action selection system 100 to provide natural language text sequences 108 characterizing the tasks to be performed by the agent. As another example, the policy system 100 and the control system 101 can interact through an API between the two system, e.g., the control system 101 can use the API to provide the observation image 106 to the policy system 100, and the policy system 100 can use the API to provide data specifying the selected actions 144 to the control system 101.

In particular, the policy system 100 and the control system 101 control the agent based on policy outputs generated by a set of neural networks that have been configured through training to control the agent 102 in response to observation images 106 characterizing the environment 104 and natural language text sequences 108 characterizing the task to be performed by the agent 102.

For example, the observation images 106 can be images captured by a camera sensor of the agent 102 or by a camera sensor located in the environment 104. The camera sensor can for example be a still camera or a video camera.

The natural language text sequences 108 can be received from another agent in the environment 104 or from the control system 101 of the agent 102. For example, another agent in the environment 104 can speak an instruction and the control system 101 or another system can transcribe it into a natural language text sequence 108, and then provide the transcription to the policy system 100. As another example, the control system 101 can receive an instruction, e.g., a text-based input, a selection-based input, or an audio-based input, entered by a user that specifies the natural language text sequence 108, and then provide the instruction to the policy system 100.

More specifically, the policy system 100 receives a natural language text sequence 108 that characterizes a task to be performed by the agent 102 in the environment 104 and processes the natural language text sequence 108 using a text encoder neural network 110 to generate an encoded representation 112 of the natural language text sequence (or “encoded text” for short).

The encoded representation 112 can be or include an embedding of the text sequence 108. An “embedding” as used in this specification is a sequence of one or more vectors of numeric values, e.g., floating point values or other values, each vector having a pre-determined dimensionality.

The text encoder neural network 110 can have any appropriate neural network architecture that allows the neural network to map the natural language text sequence 108 to an embedding of the text sequence 108. A particular example architecture will be described further below, but more generally, the text encoder neural network 110 can include any appropriate types of neural network layers (e.g., embedding layers, fully connected layers, and so forth) in any appropriate number (e.g., 2 layers, or 5 layers, or 10 layers) and connected in any appropriate configuration (e.g., as a directed graph of layers).

At each of a plurality of time steps, the policy system 100 obtains an observation image 106 characterizing a state of the environment 104 at the time step. The observation image 106 can be obtained from a camera sensor (e.g., a camera sensor of the agent 102 or a camera sensor located in the environment 104), or from the control system 101 of the agent 102. For example, the control system 101 of the agent 102 obtains, from the camera sensor, the observation image 106 of the environment 104 at the time step, and then provides the observation image 106 to the policy system 100.

In implementations where the policy system 100 is remote from the agent 102, providing the observation image 106 to the policy system 100 can include, for example, transmitting data representing the observation image 106 over the data communication network that connects the policy system 100 and the control system 101. As another example, providing the observation image 106 to the policy system 100 can include providing to the policy system 100 data that specifies a name or a network location (e.g., a Uniform Resource Locator (URL) of a server from which the policy system 100 can obtain the observation image 106.

The policy system 100 processes an input that includes the observation image 106 and, in some cases, the encoded representation 112 of the natural language text sequence using an image encoder neural network 120 to generate an encoded representation 122 of the observation image (or “encoded image” for short).

While this specification generally describes that the observations are images, in some cases the observations can include additional data in addition to image, e.g., proprioceptive data characterizing the agent or other data captured by other sensor of the agent. In these cases, the other data can be encoded jointly with the observation image 106 by the image encoder neural network 120.

When the encoded representation 112 of the natural language text sequence is also provided by the policy system 100 as a part of the input to the image encoder neural network 120, the image encoder neural network 120 generates the encoded representation 122 of the observation image that is conditioned on the encoded representation 112 of the natural language text sequence. That is, the image encoder neural network 120 uses the encoded representation 112 of the natural language text sequence as context when generating the encoded representation 122 of the observation image, i.e., so that different text sequences can result in different representations being generated for the same observation image.

A particular example architecture will be described further below, but more generally, the image encoder neural network 120 can include any appropriate types of neural network layers (e.g., convolutional layer, conditioning layers, attention layers, and so forth) in any appropriate number (e.g., 5 layers, or 10 layers, or 50 layers) and connected in any appropriate configuration (e.g., as a directed graph of layers).

The policy system 100 generates, based on the encoded representation 122 of the observation image, a sequence of input tokens 132. The sequence of input tokens 132 can include a sequence of image tokens for the observation image 106. As used in this specification, a “token” is a vector or other ordered collection of numerical values that has a fixed dimensionality, i.e., the number of values in the ordered collection is constant across different tokens.

The encoded representation 122 can include a feature map that includes a respective feature vector for each of a plurality of regions in the observation image 106. The policy system 100 can thus generate the sequence of input tokens 132 by using the feature vectors included in the feature map, or data derived from these feature vectors, as the image tokens to be included in the sequence of input tokens 132.

In some implementations, the policy system 100 applies a learned module to map the feature vectors included in the encoded representation 122 of the observation image to a smaller number of feature tokens, and then generates the sequence of input tokens 132 by using the feature vectors generated as a result of applying the learned module as the image tokens to be included in the sequence of input tokens 132.

The learned module may be, but need not be, a neural network. In the example of FIG. 1, the learned module is implemented using a neural network (the “token neural network 130”). When configured as a neural network, the learned module can include any appropriate types of neural network layers (e.g., convolutional layer, fully connected layers, attention layers, pooling layers, and so forth) in any appropriate number (e.g., 1 layer, or 5 layers, or 10 layers) and connected in any appropriate configuration (e.g., as a directed graph of layers).

A particular example architecture of a token neural network 130 will be described further below. As another example, the token neural network 130 can have a vision Transformer (ViT) architecture that includes one or more attention layers. As another example, the token neural network 130 can have a convolutional neural network architecture that includes one or more convolutional layers.

In other yet examples, the learned module can include any data values that define a learned mapping to reduce the number of feature vectors that are provided as input to the learned module, i.e., to map a larger number of feature vectors to a smaller number of feature vectors. Being “learned” means these data values are adjusted during the joint training of the set of neural networks included in the policy system 100.

After having generated the sequence of input tokens 132, the policy system 100 then processes the sequence of input tokens 132 using a Transformer neural network 140 to generate a policy output 142 that defines an action to be performed by the agent 102 in response to the observation image 106 received at the time step. The Transformer neural network 140 receives the sequence of input tokens 132 and generates, e.g., in an auto-regressive manner, a policy output 142 made up of a plurality of data values.

A particular example architecture will be described further below, but more generally, the Transformer neural network 140 can have any appropriate Transformer-based architecture, e.g., one of the architectures described in Ashish Vaswani, et al. “Attention is all you need,” Advances in neural information processing systems, 30, 2017; Peter J. Liu, et al. “Generating wikipedia by summarizing long sequence,” arXiv preprint arXiv:1801.10198 (2018); Daniel Adiwardana, et al. “Towards a human-like open-domain chatbot,” CoRR, abs/2001.09977, 2020; Tom B Brown, et al. “Language models are few-shot learners,” arXiv preprint arXiv:2005.14165, 2020; and Aakanksha Chowdhery, et al. “Palm: Scaling language modeling with pathways,” arXiv preprint arXiv:2204.02311 (2022).

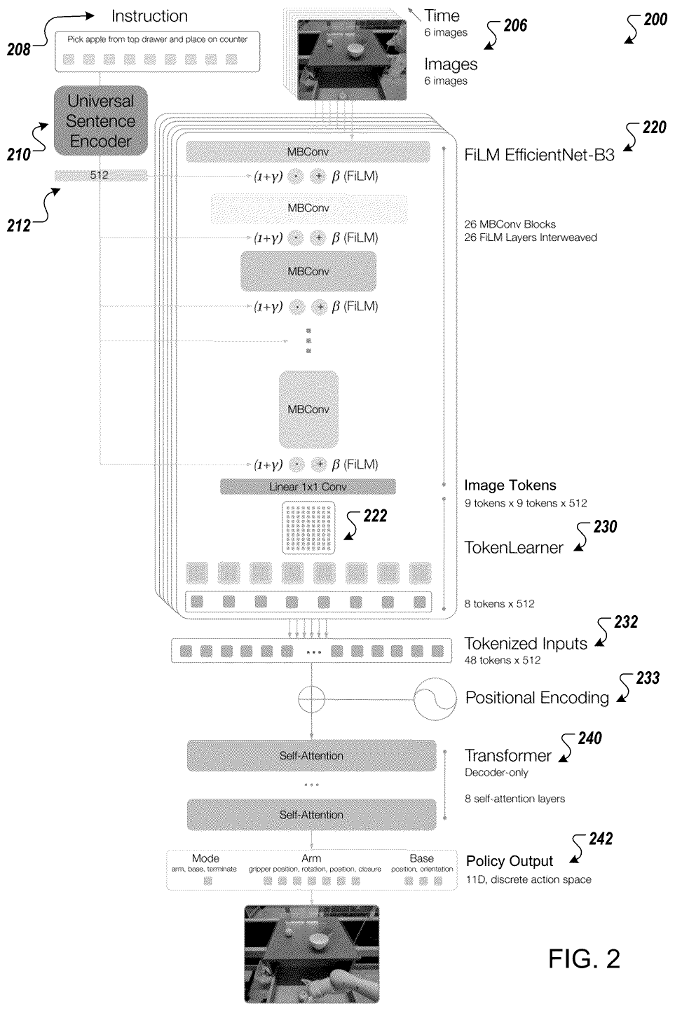

The policy system 100 selects the action 144 to be performed by the agent 102 using the policy output 142. A specific example of a policy output 142, as well as how the policy system 100 makes this action selection using such a policy output 142, will be described further below at FIG. 2.

After having selected the action 144 to be performed by the agent 102 at the time step, the policy system 100 provides data identifying the selected action 144 to the control system 101. In implementations where the policy system 100 is remote from the agent 102, providing the data identifying the selected action 144 can, for example, include transmitting data identifying the selected action 144 over the data communication network that connects the policy system 100 and the control system 101.

The control system 101 then causes the agent 102 to perform the selected action 144. For example, the control system 101 can do this by generating instructions for the agent 102 that when executed will cause the agent 102 to perform the selected action 144, by submitting a control input directly to the appropriate controls of the agent, or by using another appropriate control technique.

In some implementations, the environment 104 is a real-world environment and the agent 102 is a mechanical agent interacting with the real-world environment. For example, the agent may be a robot interacting with the environment to accomplish a goal, e.g., to locate an object of interest in the environment, to move an object of interest to a specified location in the environment, to physically manipulate an object of interest in the environment in a specified way, or to navigate to a specified destination in the environment; or the agent may be an autonomous or semi-autonomous land, air, or sea vehicle navigating through the environment to a specified destination in the environment.

The actions 144 may be control inputs to control a robot, e.g., torques for the joints of the robot or higher-level control commands, or the autonomous or semi-autonomous land or air or sea vehicle, e.g., torques to the control surface or other control elements of the vehicle or higher-level control commands.

In other words, the actions 144 can include for example, position, velocity, or force/torque/acceleration data for one or more joints of a robot or parts of another mechanical agent. Actions may additionally or alternatively include electronic control data such as motor control data, or more generally data for controlling one or more electronic devices within the environment the control of which has an effect on the observed state of the environment. For example in the case of an autonomous or semi-autonomous land, air, or sea vehicle the actions may include actions to control navigation, e.g., steering, and movement e.g., braking and/or acceleration of the vehicle.

In some implementations the environment 104 is a simulated environment and the agent 102 is implemented as one or more computer programs interacting with the simulated environment. For example, the environment can be a computer simulation of a real-world environment and the agent can be a simulated mechanical agent navigating through the computer simulation.

For example, the simulated environment may be a motion simulation environment, e.g., a driving simulation or a flight simulation, and the agent may be a simulated vehicle navigating through the motion simulation. In these implementations, the actions 144 may be control inputs to control the simulated user or simulated vehicle. As another example, the simulated environment may be a computer simulation of a real-world environment and the agent may be a simulated robot interacting with the computer simulation.

Generally, when the environment 104 is a simulated environment, the actions 144 may include simulated versions of one or more of the previously described actions or types of actions.

In some implementations, the environment 104 is a suitable execution environment, e.g., a runtime environment or an operating system environment, that is implemented on one or more computing devices such as smart phones, tablet computers, wearable devices, automobile systems, standalone personal assistant devices, and so forth, and the agent 102 is a virtual agent (also known as “automated assistant” or “mobile assistant”) that may be interacted with by a user through the computing devices. The virtual agent can receive input from the user (e.g., typed or spoken natural language input) and respond with responsive content (e.g., visual and/or audible natural language output). The virtual agent can provide a broad range of functionalities through interactions with various local and/or third-party applications, websites, or other agents. In these implementations, the actions 144 may include any activity or operation that may be performed or initiated by the user on a computing device, e.g., within an application software installed on the computing device.

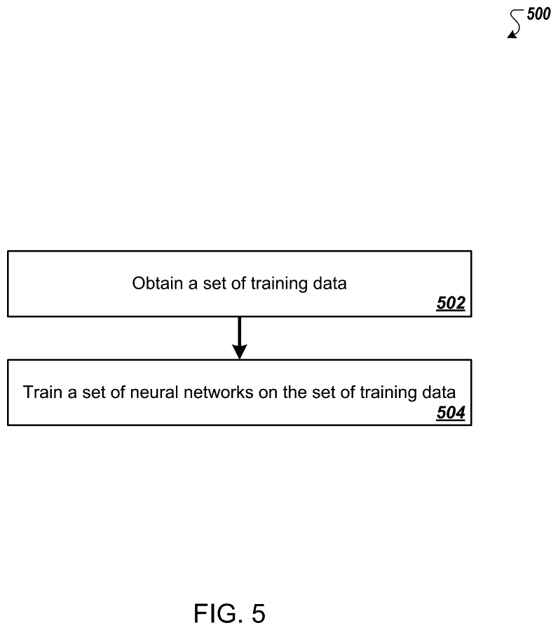

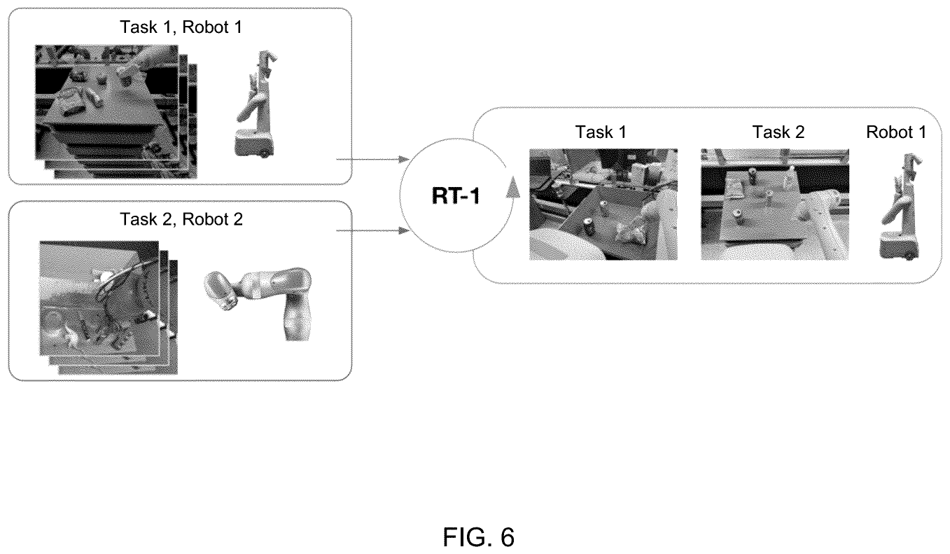

In some cases, the policy system 100 can be used to control the interactions of the agent with a simulated environment, and the policy system 100 (or another training system) can train the set of neural networks used to control the agent 102 based on the interactions of the agent 102 (or another agent) with the simulated environment to determine trained values of the parameters of the set of neural networks. Training the set of neural networks will be described in more detail below with reference to FIGS. 5-6.

After the set of neural networks are trained based on the interactions of the agent 102 (or another agent) with a simulated environment, the trained neural networks can be used by the policy system 100 to control the interactions of a real-world agent with the real-world environment, i.e., to control the agent that was being simulated in the simulated environment.

Training the neural networks based on interactions of an agent with a simulated environment (i.e., instead of a real-world environment) can avoid wear-and-tear on the agent and can reduce the likelihood that, by performing poorly chosen actions, the agent can damage itself or aspects of its environment.

FIG. 2 is an illustration of an architecture of an example policy system 200.

The policy system 200 receives a natural language text sequence 208. The natural language text sequence 208 characterizes a task to be performed by the agent in the environment. The natural language text sequence 208 may have an instructional format. For example, FIG. 2 illustrates that the natural language text sequence 208 is a natural language instruction that describes the task, “Pick apple from top drawer and place on counter.”

The policy system 200 uses a text encoder neural network 210 to process the natural language text sequence 208 to generate an encoded representation 212 of the natural language text sequence.

In the example of FIG. 2, the text encoder neural network 210 has a Universal Sentence Encoder architecture and generates a 512-dimensional embedding, i.e., a vector that include has 512 entries, with each entry being a numerical value, e.g., a floating point value. The Universal Sentence Encoder is described in more detail in Daniel Cer, et al. Universal sentence encoder. arXiv preprint arXiv:1803.11175, 2018.

In other examples, the text encoder neural network 210 can have a different architecture, and can generate an embedding that has a smaller or larger dimension. Additionally, in other examples, the text encoder neural network 210 can generate an embedding that includes a sequence of multiple embedding vectors.

At each of the plurality of time steps, the policy system 200 obtains an observation image 206 characterizing a state of the environment at the time step. In the example of FIG. 2, the agent performs a single action in response to each observation image 206, e.g., so that a new observation image is obtained by the policy system 200 after each action that the agent performs.

The policy system 100 uses an image encoder neural network 220 to generate an encoded representation 222 of the observation image 206. The encoded representation 222 can include a feature map that includes a respective feature vector for each of a plurality of regions in the observation image 206.

For example, FIG. 2 illustrates that the image encoder neural network 220 generates a feature map that includes 81 feature vectors, where each feature vector has 512 dimensions, that correspond respectively to 81 regions (e.g., 81 non-overlapping subsets of pixels) that are arranged along the horizontal and vertical dimensions in the observation image 206.

The image encoder neural network 220 can generally be configured as a convolutional neural network that includes one or more convolutional layers. As a particular example of this, FIG. 2 illustrates that the image encoder neural network 220 includes a stack of 26 inverted residual blocks (“MBConv blocks”). Inverted residual blocks are described in more detail in Mingxing Tan, et al. EfficientNet: Rethinking model scaling for convolutional neural networks. In Kamalika Chaudhuri and Ruslan Salakhutdinov (eds.), Proceedings of the 36th International Conference on Machine Learning, volume 97 of Proceedings of Machine Learning Research, pp. 6105-6114. PMLR, 09-15 Jun. 2019. URL https://proceedings.mlr.press/v97/tan19a.html.

Moreover, in the example of FIG. 2, the image encoder neural network 220 generates the encoded representation 222 of the observation image that is conditioned on the encoded representation 212 of the natural language text sequence. That is, the image encoder neural network 220 receives, as input, the encoded representation 212 of the natural language text sequence and the observation image 206, and processes the input to generate, as output, the encoded representation 222 of the observation image.

The image encoder neural network 220 uses the encoded representation 212 of the natural language text sequence as context when generating the encoded representation 222 of the observation image, i.e., so that different text sequences can result in different representations being generated for the same observation image.

To that end, the image encoder neural network 220 also includes one or more conditioning layers. The conditioning layers can be interleaved between other intermediate layers, e.g., convolutional layers, e.g., depth-wise convolutional layers, of the image encoder neural network 220.

Each conditioning layer receives, as input, (i) a respective intermediate output of a respective intermediate layer of the image encoder neural network and (ii) the encoded representation 212 of the natural language text sequence, and processes the input to (i) update the respective intermediate output of the image encoder neural network using the encoded representation 212 of the natural language instruction and (ii) provide the updated respective intermediate output as input to a respective subsequent intermediate layer of the image encoder neural network.

As a particular example of this, FIG. 2 illustrates that the image encoder neural network 220 includes 26 feature-wise Linear Modulation (FiLM) layers that are interleaved between the stack of 26 inverted residual blocks. A FiLM layer learns functions ƒ and h which output γ and β as a function of input x:

γ=ƒ(x);β=h(x)

where γ and β modulate the respective intermediate output F of the respective intermediate layer through a feature-wise affine transformation:

FiLM(F|γ,β)=γF+β.

The functions ƒ and h may be, but need not be, implemented as neural networks.

FiLM layer is described in more detail in Ethan Perez, et al. Film: Visual reasoning with a general conditioning layer. Proceedings of the AAAI Conference on Artificial Intelligence, 32(1), April 2018. doi: 10.1609/aaai.v32i1.11671.

For example, as illustrated, the image encoder neural network 220 includes a FiLM layer arranged between a first inverted residual block and a second inverted residual block in the stack. The FiLM layer receives, as input, (i) a respective intermediate output of the first inverted residual block and (ii) the encoded representation 212 of the natural language text sequence, and processes the input to (i) update the respective intermediate output of the first inverted residual block using the encoded representation 212 of the natural language instruction and (ii) provide the updated respective intermediate output as input to the second inverted residual block. Thus, instead of receiving the respective intermediate output of the first inverted residual block as input, the second inverted residual block receives the updated respective intermediate output that has been updated by the FiLM layer using the encoded representation 212 of the natural language text sequence.

The policy system 200 generates, based on the encoded representation 222 of the observation image, a sequence of input tokens 232. The sequence of input tokens 232 can include a sequence of image tokens.

As mentioned above, the encoded representation 222 of the observation image can include a feature map that includes a respective feature vector for each of a plurality of regions in the observation image 206.

In the example of FIG. 2, the policy system 200 generates an initial input sequence by flattening the feature map into a sequence of feature vectors, and then processing the initial input sequence of feature vectors using a token neural network 230 to map the initial input sequence to a reduced input sequence that includes a smaller number of feature tokens. The feature tokens included in the reduced input sequence are then used by the policy system 200 as the image tokens to be included in the sequence of input tokens 232.

As a particular example of this, FIG. 2 illustrates that the token neural network 230 has a TokenLearner architecture, and processes an initial input sequence of 81 feature vectors (generated based on flattening a feature map that includes 81 feature vectors) based on applying a spatial attention mechanism to generate a reduced input sequence that includes 8 feature tokens, where each feature token has 512 dimensions, for the observation image 206 obtained at the time step. TokenLearner is described in more detail in Michael Ryoo, et al. Tokenlearner: Adaptive space-time tokenization for videos. Advances in Neural Information Processing Systems, 34:12786-12797, 2021.

In some implementations, the sequence of input tokens 232 include only the image tokens for the observation image 206 obtained at the current time step, i.e., include only the feature tokens included in the reduced input sequence that has been generated for the observation image 206 obtained at the current time step.

In other implementations, the sequence of input tokens 232 include not only the image tokens for the observation image 206 obtained at the current time step, but also the image tokens for one or more earlier observation images obtained at one or more earlier (or, previous) time steps, i.e., the feature tokens included in the reduced input sequences that have been generated respectively for one or more earlier observation images obtained at one or more earlier time steps.

In these implementations, to speed up inference by avoiding duplicate computations, the policy system 200 can store the feature tokens included in the reduced input sequence that has been generated at each time step, and reuse them in the later time steps.

In the example of FIG. 2, the sequence of input tokens 232 includes a sequence of image tokens that is a combination, e.g., a concatenation, of (i) the feature tokens included in the reduced input sequence that has been generated for the observation image 206 obtained at the current time step, and (ii) the feature tokens included in the reduced input sequences that have been generated respectively for five earlier observation images obtained at five earlier time steps that precede the current time step. Specifically, FIG. 2 illustrates that the sequence of input tokens 232 includes a concatenation of 48 feature tokens.

Furthermore, FIG. 2 illustrates that the policy system 200 adopts a positional encoding scheme. Specifically, the policy system 200 adds a respective positional encoding 233 to (i) each image token in the sequence of image tokens for the observation image obtained at the current time step, and to (ii) each image token in the respective sequences of image tokens for the one or more earlier observation images obtained at one or more earlier time steps.

The positional encodings 233 can be determined, e.g., in accordance with a sinusoidal positional encoding scheme, or another encoding scheme, so as to uniquely identify, for each image token, a respective time step from among multiple time steps at which the image token is generated.

The policy system 200 then provides the sequence of input tokens 232 as input to the Transformer neural network 240. As a particular example, FIG. 2 illustrates that the Transformer neural network 240 has a decoder-only Transformer neural network architecture that includes 8 self-attention layers. In other examples, the Transformer neural network 240 can have a different Transformer-based architecture, e.g., an encoder-decoder Transformer neural network architecture, that includes more or fewer layers each having the same or different attention mechanisms.

In some implementations, each possible action that can be performed by the agent is defined by a respective value for each of a plurality of action dimensions. In these implementations, for each of the plurality of action dimensions, the policy output 242 can define a respective distribution over possible values for the action dimension.

In the example of FIG. 2, the agent is a robot having a base and one or more arms, where at least one of the arms has an end effector (e.g., a gripper or another tool) attached to its end. In this example, the plurality of action dimensions include 7 action dimensions for arm movement: x, y, z, roll, pitch, yaw, and status of the end effector (e.g., open/close status of the gripper). The plurality of action dimensions also include 3 action dimensions for base movement: x, y, yaw. The plurality of action dimensions further include an action dimension for mode switch (e.g., for switching between controlling an arm of the robot, controlling the base of the robot, or terminating the episode).

In other examples, the agent may be a different type of robot, or it may be a vehicle or another type of agent as mentioned above, and each possible action that can be performed by the agent may thus be characterized by a different set of action dimensions.

In any example, the possible values for an action dimension can be discretized into a fixed number of bins, and the policy output 242 can include data values that define a distribution over the fixed number of bins for the action dimension. The distribution can be a categorical distribution (a respective discrete probability distribution) that assigns a respective probability score to each bin in the fixed number of bins for the action dimension.

In some of these implementations, for each action dimension, the fixed number of bins can correspond to about equal number of possible values for the action dimension. For example, the possible values for the roll (or, analogously, pitch, or yaw) action dimension have a range from 0 to 360 degrees, which be divided into 32 bins (each bin corresponding to a range that spans 11.25 degrees), 128 bins (each bin corresponding to a range that spans about 2.81 degrees), 256 bins (each bin corresponding to a range that spans about 1.41 degrees), and so forth. As another example, the possible values for the mode switch action dimension are 0 (controlling an arm of the robot), 1 (controlling the base of the robot), and 2 (terminating the episode), which be divided into 3 bins (each bin corresponding to a respective value), 256 bins (about 85 bins each corresponding to a same respective value), and so forth.

In some other implementations, the policy output 242 can have a different format that defines or otherwise specifies an action. For example, the policy output 242 can be a natural language description of the action to be performed by the agent, e.g., “move arm to position (x, y, z),” “move arm to pose (x, y, z, roll, pitch, yaw),” or “open gripper.” As another example, the policy output 242 can be a sequence of data elements representing the action, e.g., an identifier of the action, to be performed by the agent.

To select the action to be performed by the agent at the time step, the policy system 200 then selects, for each of one or more of the action dimensions, a respective value within the possible values for the action dimension using the respective distribution. For example, the policy system 200 can greedily select the highest-scoring bin or can sample, e.g., using nucleus sampling or another sampling technique, a bin from the respective distribution defined by the policy output 242 for an action dimension, and then select a value that corresponds to, e.g., falls within, the selected bin as the selected value for the action dimension.

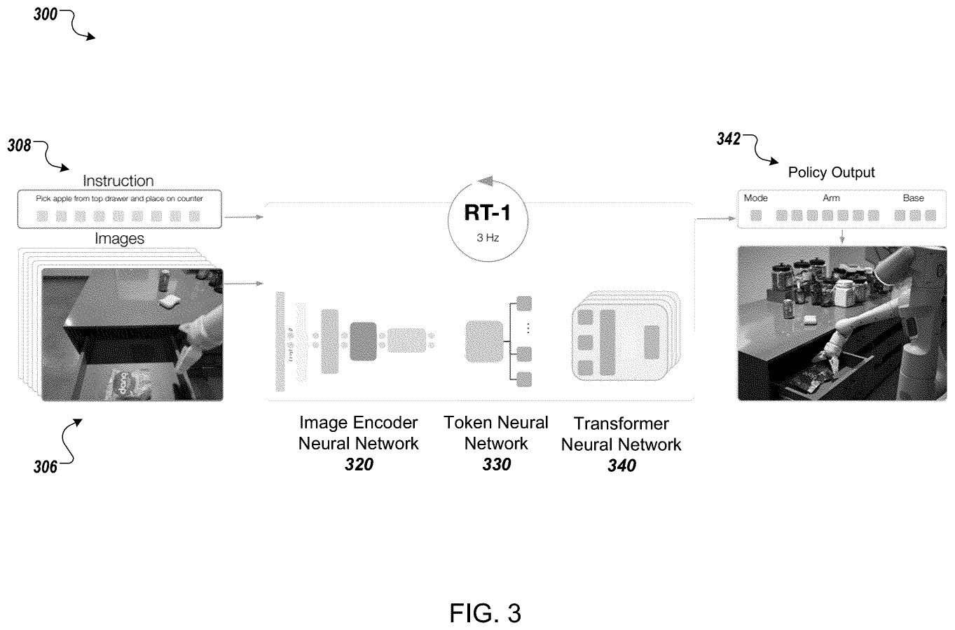

FIG. 3 is an illustration of operations performed by an example policy system 300. The policy system 300 can be the same as or similar to the policy system 200 in FIG. 2. The policy system 300 can control an agent to accomplish a task in an environment by repeatedly performing one iteration of these operations at each of a plurality of time steps to select an action to be performed by the agent in response to obtaining an observation image captured within or of the environment at the time step.

At a high level, at each of a plurality of time steps, the operations involve receiving data derived from a sequence of observations images and a natural language text sequence as input, and processing the data to generate a policy output that defines an action to be performed by the agent at the time step.

In particular, when configured to have the architecture described in FIG. 2, the policy system 300 can repeatedly performing these operations at a frequency of 3 Hz, or above. That is, the policy system is capable of selecting three or more actions to be performed by the agent (in response to obtaining three or more or more observation images) per second, which is on par with a control frequency that would be achieved by, e.g., a person who is skilled at the task to be performed by the agent.

As illustrated, the policy system 300 receives a natural language text sequence 308, and processes the natural language text sequence 308 using a text encoder neural network to generate an encoded representation of the natural language text sequence. The natural language text sequence 308 may have an instruction format that defines a task to be performed by the agent in the environment.

As each of a plurality of time steps, the policy system 300 obtains an observation image 306 that characterizes a state of the environment at the time step, and then provides the observation image 306 to the set of neural networks included in the policy system 300 for further processing to select an action to be performed by the agent in response to the observation image 306.

The set of neural networks includes an image encoder neural network 320. The image encoder neural network 320 process both the observation image 306 and the encoded representation of the natural language text sequence to generate an encoded representation of the observation image. The encoded representation includes a feature map that includes a respective feature vector for each of a plurality of regions in the observation image 306.

The set of neural networks also includes a token neural network 330. The policy system 300 flattens the feature map into a sequence of feature vectors, and the processes the initial input sequence of feature vectors using the token neural network 330 to generate a reduced input sequence that includes a smaller number of feature tokens.

The policy system 300 generates a sequence of input tokens from the feature tokens generated for the current observation image 306 obtained at the current time step, and, optionally, feature tokens generated for one or more earlier observation image obtained at one or more earlier time steps.

The set of neural networks further includes a Transformer neural network 340. The Transformer neural network 340 processes the sequence of input tokens to generate a policy output 342 that defines an action to be performed by the agent in response to the observation image 306.

The policy system 300 selects an action to be performed by the agent using the policy output, and then causes the agent to perform the selected action.

The policy system 300 can repeat these operations at the frequency of 3 Hz, or above, until some termination condition has been met, e.g., until it generates a particular policy output 342 that defines a terminal action, until a predetermined number of iterations of these operations have been performed, or until a predetermined length of time has lapsed.

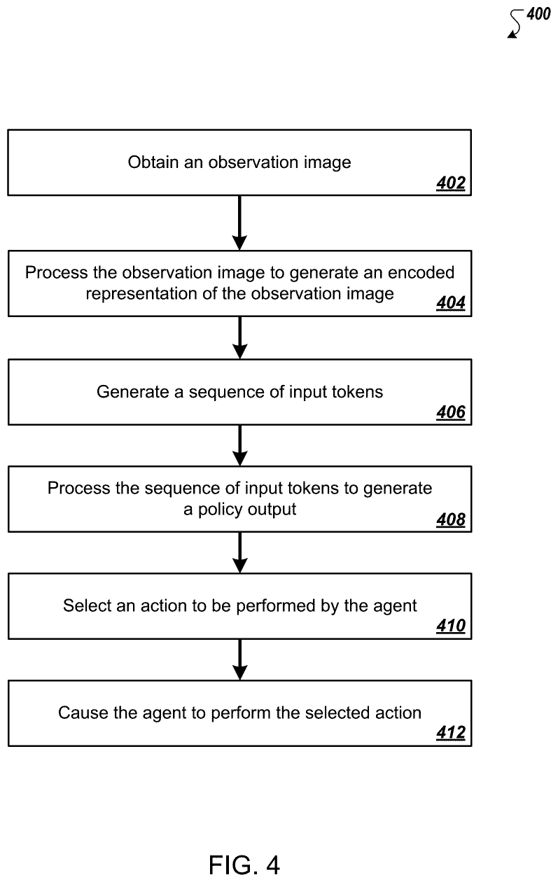

FIG. 4 is a flow diagram of an example process 400 for controlling an agent interacting with an environment. For convenience, the process 400 will be described as being performed by a system of one or more computers located in one or more locations. For example, a policy system, e.g., the policy system 100 of FIG. 1, appropriately programmed in accordance with this specification, can perform the process 400.

The system controls the agent to accomplish a task in the environment by repeatedly performing an iteration of the process 400 at each of a plurality of time steps (referred to below as the “current” time step).

The task that will be performed by the agent is characterized by a natural language text sequence. For example, prior to the first iteration of the process 400, the system receives a natural language text sequence that characterizes a task to be performed by the agent in the environment, and generates an encoded representation of the natural language text sequence. For example, the encoded representation includes an embedding of the natural language text sequence, and the system can generate the embedding by processing the natural language text sequence using a text encoder neural network.

The system obtains an observation image characterizing a state of the environment at the current time step (step 402). For example, the observation image can be captured by a camera sensor of the agent or by a camera sensor located in the environment.

The system processes the observation image using an image encoder neural network that is conditioned on the encoded representation of the natural language text sequence to generate an encoded representation of the observation image (step 404). That is, the image encoder neural network receives, as input, the encoded representation of the natural language text sequence and the observation image, and processes the input to generate, as output, the encoded representation of the observation image.

The system generates, from at least the encoded representation of the observation image, a sequence of input tokens (step 406). The sequence of input tokens can include a sequence of image tokens for the current observation image obtained at the current time step. Optionally, the sequence of input tokens can also include a sequence of image tokens for each of one or more earlier observation image obtained at one or more earlier time steps.

For example, the encoded representation can include a feature map that includes a respective feature vector for each of a plurality of regions in the observation image. In this example, the system can generate an initial input sequence by flattening the feature map into a sequence of feature vectors, and then processing the initial input sequence of feature vectors using a learned module that maps the initial input sequence to a reduced input sequence that includes a smaller number of feature tokens. The feature tokens included in the reduced input sequence can then be used as the image tokens to be included in the sequence of input tokens.

The system processes the sequence of input tokens using a Transformer neural network to generate a policy output that defines an action to be performed by the agent in response to the observation image obtained at the current time step (step 408). Each possible action that can be performed by the agent is defined by a respective value for each of a plurality of action dimensions. To define the action to be performed by the agent, the policy output generated by the Transformer neural network includes, for each of the plurality of action dimensions, a respective categorical distribution over possible values for the action dimension.

The system selects an action to be performed by the agent using the policy output (step 410). This selection can be made by selecting a respective value for one or more of the plurality of action dimensions using the respective categorical distributions that are defined by the policy output of the Transformer neural network.

The system causes the agent to perform the selected action (step 412), e.g., by directly submitting the control input to the agent or by transmitting instructions or other data, e.g., over a data communication network, to a control system for the agent that will cause the agent to perform the selected action.

The process 400 can be performed when controlling an agent to perform a task in which the actions that should be performed, e.g., actions that would result in progression towards accomplishing the task, are not known. The process 400 can also be performed as part of selecting actions to be performed by an agent based on processing observation images derived from a set of training dataset, i.e., observation images the actions in response to which that should be performed by the agent is known, in order to train the set of neural networks to determine trained values for the parameters of the neural networks.

FIG. 5 is a flow diagram of an example process 500 for training a set of neural networks included in a policy system. For convenience, the process 500 will be described as being performed by a system of one or more computers located in one or more locations. For example, a policy system, e.g., the policy system 100 of FIG. 1, or another training system, appropriately programmed in accordance with this specification, can perform the process 500.

To train the set of neural networks, the system obtains a set of training data (step 502). The set of training data can include training data generated based on the interactions of the agent (or another agent) with an environment.

In one example, the training dataset includes N training examples

$$D = {\{ ( {i}^{( n )} , \{ ( {x}_{t}^{( n )} , {a}_{t}^{( n )} ) \} {T}_{t = 0}^{( n )} ) \}}_{n = 0}^{N} .$$

Each training example corresponds to a respective episode that spans multiple time steps that each begin from t=0 and ends at t=T(n), when an agent, e.g., agent 102 of FIG. 1, or another agent, successfully accomplished a task; in each training example, i represents the natural language text sequence, xₜ represents the observation image obtained at time step t, and at represents the action performed by the agent at time step t. Different episodes may have varying lengths, i.e., may include different numbers of time steps.

For example, the training dataset can include the training examples collected when the agent 102 of FIG. 1, or another agent, is performing one or more of the following tasks listed below in Table 1.

TABLE 1

| Description | Example Instruction |
|---|---|
| Lift the object off the surface | pick iced tea can |
| Move the first object near the | move pepsi can near rxbar |
| second | blueberry |
| Place an elongated object upright | place water bottle upright |
| Knock an elongated object over | knock redbull can over |
| Open any of the cabinet drawers | open the top drawer |
| Close any of the cabinet drawers | close the middle drawer |
| Place an object into a receptacle | place brown chip bag into white bowl |
| Pick an object up from a location | pick green jalapeno chip bag from |
| and then place it on the counter | paper bowl and place on counter |

In some cases, the training dataset includes expert interaction data characterizing interactions of one or more expert agents with a corresponding environment. An expert agent can be any agent that selects actions in response to observation images in accordance with an action selection policy that cause the expert agent to make effective progress towards accomplishing a task. For example, the expert agent may be an agent controlled by another already trained policy system, a person who is skilled at the task to be performed by the agent, and so forth.

In some of these cases, the expert interaction data includes simulation data, where a simulated expert agent performs one or more tasks in a simulated environment. In others of these, the expert interaction data includes real-world data, where a real-world expert agent performs one or more tasks in a real-world environment. In yet other cases, the expert interaction data includes both simulation data and real-world data.

In some cases, the training dataset includes training examples that are generated from one or more robots of the same model (and therefore have identical physical characteristics), e.g., when they were performing the same or different tasks, e.g., one of the tasks mentioned above in Table 1, or other tasks.

In other cases, the training dataset can be a mixed training dataset that includes training examples generated from multiple robots that are not the same model, located at the same site, or even built by the same manufacturer. For example, the mixed training data can be generated from tens or hundreds of different robots having different physical characteristics and being different models. In addition, the mixed training data does not need to be generated from physical robots. For example, the mixed training data can include data generated from simulations of physical robots.

FIG. 6 is an illustration of training a set of neural networks on a mixed training dataset. FIG. 6 illustrates that the system obtains a first set of training examples generated from a first robot performing a first task, and a second set of training examples generated from a second robot performing a second task. The first robot and the second robot have different physical characteristics and are built by different manufacturers. The set of neural networks can then be trained to select actions to be performed by the first robot to perform both the first task and the second task.

Generally, the more diverse the training dataset, the better the system can generalize to unseen robotic control tasks once trained on the training dataset, e.g., tasks that are characterized by unseen instructions, tasks that involve selecting actions in response to observation images collected within or about unseen environments, tasks that involve unseen objects, and so forth. The increased diversity of the training dataset may also enhance the robustness of the system against possible distractions, e.g., new obstacles, new background scenes, and so forth, that might occur in tasks that were previously seen during training.

The system trains a set of neural networks on the set of training data (step 504). The set of neural networks can include the text encoder neural network 110, the image encoder neural network 120, the token neural network 130, and the Transformer neural network 140 of FIG. 1.

To train the set of neural networks, the system selects training examples from the training dataset and, for each training example selected from the training dataset, generates training policy outputs that define actions to be performed by an agent based on processing the natural language text sequence and the observation images included in the training example. For example, step 502 can involve performing multiple iterations of the process 400.

The system updates the values for the parameters of the neural networks based on using a machine learning training technique, e.g., a gradient descent with backpropagation training technique that uses a suitable optimizer, e.g., stochastic gradient descent, RMSprop, or Adam optimizer, to optimize an objective function.

For example. The objective function can be a cross-entropy objective function, or another objective function, that evaluates, for each training example selected from the training dataset, a difference between (i) training policy outputs generated by the set of neural networks from processing the natural language text sequence and the observation images included in the training example and (ii) ground truth policy outputs defining the actions included in the training example.

During training, the system can incorporate any number of techniques to improve the speed, the effectiveness, or both of the training process.

For example, rather than training each of the set of neural networks from scratch, e.g., from initial parameter values, the system can train the set of neural networks starting from the pre-trained parameter values of some of the neural networks.

In some cases, the text encoder neural network can be pre-trained, e.g., as a part of a larger text processing neural network, on a text processing task, e.g., a text representation learning task, prior to the joint training of the set of neural network. In some of these cases, the text encoder neural network is then fine-tuned during the joint training, while in others of these cases, the text encoder neural network is held frozen during the joint training, i.e., the joint training of neural networks on the training dataset does not adjust the pre-trained parameter values of the pre-trained text encoder neural network.

In some cases, the image encoder neural network can be pre-trained, e.g., as a part of a larger image processing neural network, on an image processing task, e.g., an image classification or segmentation task, and then fine-tuned during the joint training of the set of neural networks on the training dataset.

In some of these cases, the image encoder neural network does not include the one or more conditioning layers for the pre-training. For example, the image encoder neural network can be trained as part of a neural network that is being trained to classify image into a set of categories without conditioning on any natural language text sequence as context.

Moreover, in some of these cases, because inserting the conditioning layers as new layers into such a pre-trained image encoder neural network might cause disruption to the intermediate outputs of the neural network, prior to the joint training, the system initializes each conditioning layer to act as an identity transformation to the corresponding respective intermediate output. This can be done, for example, by setting the at least some of the parameter values associated with each conditioning layer to zeros.

As another example, the joint training of the set of neural networks can include imitation learning. For example, when the training dataset includes expert interaction data, the system can train the set of neural networks through behavior cloning on the expert interaction data to generate training policy outputs from which actions that closely mimic those performed by the expert agents can be selected.

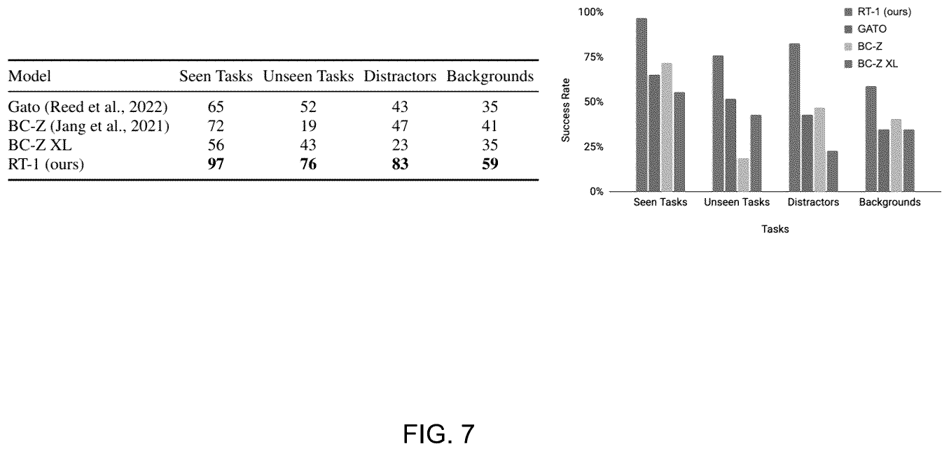

FIG. 7 shows a quantitative example of the performance gains that can be achieved by using a policy system described in this specification. Specifically, FIG. 7 shows overall performance of an agent (in term of success rate) controlled using the policy 100 of FIG. 1 (“RT-1”) and agents controlled using baseline systems across seen tasks, generalization capability to unseen tasks, and robustness against distractors and backgrounds.

The baseline systems include a Gato system (described in Reed, Scott, et al. “A generalist agent.” arXiv preprint arXiv:2205.06175 (2022)), a BC-Z system (described in Jang, Eric, et al. “Bc-z: Zero-shot task generalization with robotic imitation learning.” Conference on Robot Learning. PMLR, 2022), and a BC-Z XL system (the BC-Z system with a larger number of parameters).

In FIG. 7, “seen tasks” are tasks that were seen during training, i.e., tasks on which the policy system has been trained; “unseen tasks” are tasks that involve instructions and object(s) were seen separately in the training dataset, but combined in new ways; “distractors” are tasks that involve distractor objects previously unseen during training; and “backgrounds” are tasks that involve an environment having previously unseen backgrounds, e.g., backgrounds with different scenes or different illuminations).

It can be appreciated that, RT-1 outperforms these baseline systems by large margins on all of these tasks. In particular, RT-1 has high general performance on seen tasks (97% success rate vs 72% of BC-Z, the highest success rate among all baseline systems), and additionally has impressive degrees of generalization capability (76% success rate vs 52% of Gato) and robustness (83% success rate vs 47% of BC-Z on distractors and 59% success rate vs 41% of BC-Z on backgrounds).

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers and for controlling an agent interacting with an environment, the method comprising:
receiving a natural language text sequence that characterizes a task to be performed by the agent in the environment;
generating an encoded representation of the natural language text sequence; and
at each of a plurality of time steps:
obtaining an observation image characterizing a state of the environment at the time step;
processing the observation image using an image encoder neural network that is conditioned on the encoded representation of the natural language text sequence to generate an encoded representation of the observation image;
generating, from at least the encoded representation of the observation image, a sequence of input tokens;
processing the sequence of input tokens using a Transformer neural network to generate a policy output that defines an action to be performed by the agent in response to the observation image;
selecting an action to be performed by the agent using the policy output; and
causing the agent to perform the selected action.

2. The method of claim 1, wherein the environment is a real-world environment and the agent is a robot.

3. The method of claim 1, wherein generating, from at least the encoded representation of the observation image, a sequence of input tokens comprises:
generating, from the encoded representation of the observation image, a sequence of image tokens for the observation image.

4. The method of claim 3, wherein generating, from at least the encoded representation of the observation image, a sequence of input tokens comprises:
generating the sequence of input tokens by combining the sequence of image tokens for the observation image with respective sequences of image tokens for one or more earlier observation images received at one or more earlier time steps.

5. The method of claim 4, wherein combining the sequence of image tokens for the observation image with respective sequences of image tokens for each of one or more earlier observation images received at one or more earlier time steps comprises applying positional encodings to each image token in the sequence of image tokens for the observation image and the respective sequences of image tokens for the one or more earlier observation images.

6. The method of claim 3, wherein the encoded representation comprises a feature map that includes a respective feature vector for each of a plurality of regions in the observation image, and wherein generating, from the encoded representation of the observation image, a sequence of image tokens for the observation image comprises:
generating an initial input sequence by flattening the feature map into a sequence of feature vectors.

7. The method of claim 6, wherein generating, from the encoded representation of the observation image, a sequence of image tokens for the observation image comprises:
processing the initial input sequence of feature vectors using a learned module that maps the initial input sequence to a reduced input sequence that includes a smaller number of feature tokens.

8. The method of claim 1, wherein the image encoder neural network comprises one or more conditioning layers that are each configured to receive a respective intermediate output of a respective intermediate layer of the image encoder neural network and the encoded representation of the natural language instruction and to (i) update the respective intermediate output of the image encoder neural network using the encoded representation of the natural language instruction and (ii) provide the updated respective intermediate output as input to a respective subsequent intermediate layer of the image encoder neural network.

9. The method of claim 8, wherein the one or more conditioning layers are feature-wise Linear Modulation (FiLM) layers.

10. The method of claim 8, wherein the image encoder neural network is a convolutional neural network and the respective intermediate layer, the respective subsequent layer, or both are convolutional layers.

11. The method of claim 1, wherein the Transformer is a decoder-only Transformer.

12. The method of claim 1, wherein the policy output comprises, for each of a plurality of action dimensions, a respective categorical distribution over possible values for the action dimension.

13. The method of claim 12, wherein selecting an action to be performed by the agent using the policy output comprises selecting a respective value for one or more of the action dimensions using the respective categorical distributions.

14. The method of claim 1, wherein the image encoder neural network and the Transformer neural network have been trained jointly on a set of training data.

15. The method of claim 14, wherein, prior to the joint training, the image encoder neural network has been pre-trained on an image classification task.

16. The method of claim 15, when dependent on claim 8, wherein the image encoder neural network does not include the one or more conditioning layers for the pre-training.

17. The method of claim 8, wherein each conditioning layer is, prior to the joint training, initialized to act as an identity transformation to the corresponding respective intermediate output.

18. The method of claim 7, wherein the learned module has also been trained as part of the joint training.

19. The method of claim 14, wherein the joint training comprises training through imitation learning and the training data comprises expert interaction data characterizing interactions of one or more expert agents with a corresponding environment.

20. The method of claim 19, wherein the expert interaction data includes simulation data.

21. The method of claim 19, wherein the expert interaction data includes real-world data.

22. The method of claim 20, wherein the expert interaction data includes both simulation data and real-world data.

23. The method of claim 1, wherein generating an encoded representation of the natural language text sequence comprises processing the natural language text sequence using a text encoder neural network to generate an embedding of the natural language text sequence.

24. The method of claim 22, wherein the text encoder neural network is pre-trained on a text representation learning task.

25. The method of claim 14, wherein the text encoder neural network is fine-tuned during the joint training.

26. The method of claim 14, wherein the text encoder neural network is held frozen during the joint training.

27. The method of claim 1, wherein the agent is a robot and the one or more computers are on-board the robot.

28. A system comprising one or more computers and one or more storage devices storing instructions that when executed by the one or more computers cause the one more computers to perform operations for controlling an agent interacting with an environment, wherein the operations comprise:
receiving a natural language text sequence that characterizes a task to be performed by the agent in the environment;
generating an encoded representation of the natural language text sequence; and
at each of a plurality of time steps:
obtaining an observation image characterizing a state of the environment at the time step;
processing the observation image using an image encoder neural network that is conditioned on the encoded representation of the natural language text sequence to generate an encoded representation of the observation image;
generating, from at least the encoded representation of the observation image, a sequence of input tokens;
processing the sequence of input tokens using a Transformer neural network to generate a policy output that defines an action to be performed by the agent in response to the observation image;
selecting an action to be performed by the agent using the policy output; and
causing the agent to perform the selected action.

29. One or more computer storage media storing instructions that when executed by one or more computers cause the one more computers to perform operations for controlling an agent interacting with an environment, wherein the operations comprise:
receiving a natural language text sequence that characterizes a task to be performed by the agent in the environment;
generating an encoded representation of the natural language text sequence; and
at each of a plurality of time steps:
obtaining an observation image characterizing a state of the environment at the time step;
processing the observation image using an image encoder neural network that is conditioned on the encoded representation of the natural language text sequence to generate an encoded representation of the observation image;
generating, from at least the encoded representation of the observation image, a sequence of input tokens;
processing the sequence of input tokens using a Transformer neural network to generate a policy output that defines an action to be performed by the agent in response to the observation image;
selecting an action to be performed by the agent using the policy output; and
causing the agent to perform the selected action.
